(19) United States
(12) Patent Application Publication
(10) Pub. No.: US 2026/0306218 A1
(43) Pub. Date: Oct. 8, 2026

(54) System And Method For Predicting Tooth Movement & Fabricating Orthodontic Appliances

(71) Applicant: Solventum Intellectual Properties Company, Maplewood, MN (US)

(72) Inventors: Karl J.L. Geisler, Saint Paul, MN (US); Nicholas T. Poeschl, Plymouth, MN (US); Nicholas D. Bobeldyk, Champlin, MN (US)

(21) Appl. No.: 19/482,531

(22) PCT Filed: May 13, 2024
(86) PCT No.: PCT/US2024/029079

§ 371 Date: Nov. 7, 2025

Related U.S. Application Data
(60) Provisional application No. 63/466,912, filed on May 16, 2023.

(51) Int. Cl. A61C 7/00; A61C 7/08

(52) U.S. Cl. CPC A61C 7/002; A61C 7/08

(57) ABSTRACT

A computer-implemented method for predicting tooth positions includes a) defining a plurality of tooth positions corresponding to a plurality of teeth in a dental arch; b) defining a plurality of appliance positions of an orthodontic appliance; c) determining, for each tooth, one or more tooth position differences; d) determining, for each tooth, one or more appliance position differences; e) determining, for each tooth, one or more appliance-tooth relative differences; f) modifying each of the plurality of tooth positions based on the corresponding one or more appliance-tooth relative differences; g) iteratively repeating steps c) to f) until a maximum change in each of the plurality of tooth positions is less than a convergence threshold; and h) defining the plurality of tooth positions obtained in the final iteration of step g) as a plurality of predicted tooth positions.

### TECHNICAL FIELD

The present disclosure relates generally to a computer-implemented method for predicting tooth movement in an orthodontic treatment.

### BACKGROUND

Orthodontic appliances, such as aligners, may be used in an orthodontic treatment for moving one or more teeth of a patient from an undesirable arrangement (e.g., a maloccluded arrangement) toward a desired arrangement (e.g., closer to ideal, functional, and/or aesthetic arrangement).

Orthodontic treatments utilizing aligners generally include a plurality of successive orthodontic treatment stages that incorporate a successive application of a series, or sequence, of aligners. The series of aligners may successively move the one or more teeth toward the desired arrangement.

It may be important to account for appliance mechanics while planning an orthodontic treatment in order to prevent development of orthodontic treatment stages that are physically unattainable. Consequently, orthodontic treatments are currently designed using various engineering-based methods, which typically include combining a detailed three-dimensional digital model of crowns, roots, and periodontal ligaments (PDLs) associated with the one or more teeth with a detailed three-dimensional digital model of an aligner and its associated material properties. Finite-element analysis is typically used to evaluate an effectiveness of a design of the aligner.

However, finite-element and other analysis methods that employ such detailed three-dimensional models may be computationally intensive, slow, and may suffer from convergence issues. As a result, such analysis methods may be impractical to pursue in real-time during orthodontic treatment planning processes. Moreover, such analysis methods typically include determining forces required to move the one or more teeth to the desired arrangement, when, in fact, tooth movement occurs over a wide range of forces. There is no consensus in the academic literature on optimum forces or minimum forces required for tooth movement.

### SUMMARY

In one aspect, the present disclosure provides a computer-implemented method for predicting tooth movement in an orthodontic treatment. The computer-implemented method includes a) defining a plurality of tooth positions corresponding to a plurality of teeth in a dental arch. Each tooth position from the plurality of tooth positions is defined by a tooth coordinate system that is associated with a crown of a respective tooth from the plurality of teeth. The computer-implemented method further includes b) defining a plurality of appliance positions of an orthodontic appliance. Each appliance position from the plurality of appliance positions is defined by an appliance coordinate system that is associated with the orthodontic appliance and corresponds to the respective tooth. The computer-implemented method further includes c) determining, for each tooth, one or more tooth position differences. Each of the one or more tooth position differences is defined as a difference between the tooth position of a respective adjacent tooth that is adjacent to the respective tooth and the tooth position of the respective tooth. The computer-implemented method further includes d) determining, for each tooth, one or more appliance position differences. Each of the one or more appliance position differences is defined as a difference between the appliance position corresponding to the respective adjacent tooth that is adjacent to the respective tooth and the appliance position corresponding to the respective tooth. The computer-implemented method further includes e) determining, for each tooth, one or more appliance-tooth relative differences. Each of the one or more appliance-tooth relative differences is based on the one or more tooth position differences and the one or more appliance position differences of the respective tooth. The computer-implemented method further includes f) modifying each of the plurality of tooth positions based on the corresponding one or more appliance-tooth relative differences. A change in each of the plurality of tooth positions is less than or equal to a maximum predetermined change value. The computer-implemented method further includes g) iteratively repeating steps c) to f) until a maximum change in each of the plurality of tooth positions is less than a convergence threshold. The computer-implemented method further includes h) defining the plurality of tooth positions obtained in the final iteration of step g) as a plurality of predicted tooth positions of the orthodontic treatment.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic perspective view of an orthodontic appliance according to an embodiment of the present disclosure;

FIG. 2 is a flowchart illustrating various steps of a computer-implemented method for predicting tooth movement according to an embodiment of the present disclosure.

FIG. 3 is a flowchart illustrating various additional steps of the computer-implemented method according to an embodiment of the present disclosure;

FIG. 4 is a schematic perspective view of a portion of a dental arch including a plurality of teeth;

FIG. 5A is a schematic perspective view of a tooth from the plurality of teeth of FIG. 3;

FIG. 5B is a second schematic perspective view of the tooth of FIG. 5A;

FIG. 6 is a graph depicting a variation of a tooth movement factor of a tooth according to an embodiment of the present disclosure; and

FIG. 7 is a schematic view illustrating various positions of a tooth according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As recited herein, all numbers should be considered modified by the term “about.” As used herein, “a,” “an,” “the,” “at least one,” and “one or more” are used interchangeably.

As used herein as a modifier to a property or attribute, the term “generally,” unless otherwise specifically defined, means that the property or attribute would be readily recognizable by a person of ordinary skill but without requiring absolute precision or a perfect match (e.g., within +/−20% for quantifiable properties).

The term “substantially.” unless otherwise specifically defined, means to a high degree of approximation (e.g., within +/−10% for quantifiable properties) but again without requiring absolute precision or a perfect match.

The term “about,” unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

As used herein, “at least one of A and B” should be understood to mean “only A, only B, or both A and B.”

Unless specified or limited otherwise, the terms “attached,” “connected,” “coupled,” and variations thereof, are used broadly and encompass both direct and indirect attachments, connections, and couplings.

As used herein, the term “configured to” is at least as restrictive as the term “adapted to” and requires actual design intention to perform the specified function rather than mere physical capability of performing such a function.

The present disclosure relates to a computer-implemented method for predicting tooth movement in an orthodontic treatment. The computer-implemented method includes a) defining a plurality of tooth positions corresponding to a plurality of teeth in a dental arch. Each tooth position from the plurality of tooth positions is defined by a tooth coordinate system that is associated with a crown of a respective tooth from the plurality of teeth. The computer-implemented method further includes b) defining a plurality of appliance positions of an orthodontic appliance. Each appliance position from the plurality of appliance positions is defined by an appliance coordinate system that is associated with the orthodontic appliance and corresponds to the respective tooth. The computer-implemented method further includes c) determining, for each tooth, one or more tooth position differences. Each of the one or more tooth position differences is defined as a difference between the tooth position of a respective adjacent tooth that is adjacent to the respective tooth and the tooth position of the respective tooth. The computer-implemented method further includes d) determining, for each tooth, one or more appliance position differences. Each of the one or more appliance position differences is defined as a difference between the appliance position corresponding to the respective adjacent tooth that is adjacent to the respective tooth and the appliance position corresponding to the respective tooth. The computer-implemented method further includes e) determining, for each tooth, one or more appliance-tooth relative differences. Each of the one or more appliance-tooth relative differences is based on the one or more tooth position differences and the one or more appliance position differences of the respective tooth. The computer-implemented method further includes f) modifying each of the plurality of tooth positions based on the corresponding one or more appliance-tooth relative differences. A change in each of the plurality of tooth positions is less than or equal to a maximum predetermined change value. The computer-implemented method further includes g) iteratively repeating steps c) to f) until a maximum change in each of the plurality of tooth positions is less than a convergence threshold. The computer-implemented method further includes h) defining the plurality of tooth positions obtained in the final iteration of step g) as a plurality of predicted tooth positions of the orthodontic treatment.

The computer-implemented method of the present disclosure may be computationally efficient and fast in predicting tooth movement, especially when compared to solid model analysis (such as finite-element methods). In some cases, the computer-implemented method may reduce a time taken to predict tooth movement by over 99% compared to solid model analysis. For example, the computer-implemented method may predict tooth movement in the order of minutes, as compared to days or even weeks taken by solid model analysis. As a result, the computer-implemented method may be suitable for use in real-time during an orthodontic treatment planning process.

The computer-implemented method may determine an effectiveness of the orthodontic appliance without calculating forces (e.g., minimum or optimal forces) that will be applied by the orthodontic appliance on the plurality of teeth, which are somewhat arbitrary and unknowable. Moreover, the computer-implemented method may not require detailed root or periodontal ligament (PDL) geometry of the plurality of teeth to determine tooth movement. Further, the computer-implemented method may be used to modify the orthodontic treatment, and/or staging of the orthodontic treatment.

The computer-implemented method may account for fundamental aspects of appliance mechanics, capture reactions between neighboring teeth, and facilitate production of appliance designs that come closer to achieving intended tooth movements without using finite-element methods. The computer-implemented method may further account for movement of each of the plurality of teeth in six degrees of freedom (e.g., three rotational and three translational degrees of freedom).

The computer-implemented method may be performed by a processor of a computing device. The processor may include any suitable type of processing circuitry, such as one or more of a general-purpose processor (e.g., ARM-based processor), a digital signal processor (DSP), a programmable logic device (PLD), an application-specific integrated circuit (ASIC), a field-programmable gate array (FPGA), etc.

Advantageously, the computer-implemented method may be coded into computer-executable instructions that cause the processor of the computing device to perform various steps of the computer-implemented method. The computer-executable instructions may be written in any programming language, such as java. C++, python, etc. Moreover, the computer-implemented method may be integrated directly into an orthodontic treatment planning software and/or orthodontic appliance design software.

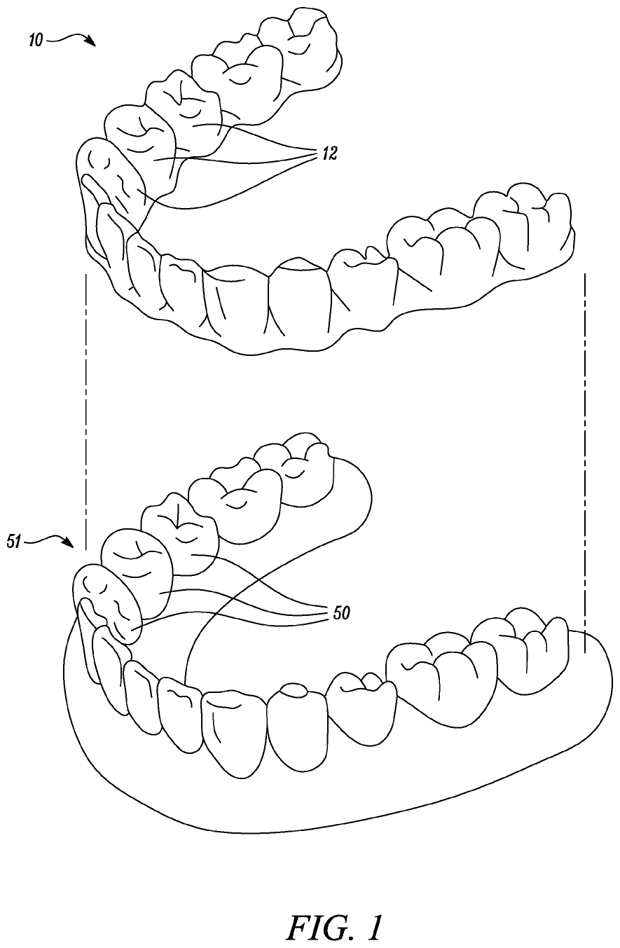

Referring now to the Figures, FIG. 1 illustrates a schematic perspective view of an orthodontic appliance 10 according to an embodiment of the present disclosure. FIG. 1 further illustrates a schematic perspective view of a dental arch 51 of a patient undergoing an orthodontic treatment.

The dental arch 51 includes a plurality of teeth 50. The plurality of teeth 50 may include one or more of a central incisor, a lateral incisor, a canine, a first premolar, a second premolar, a first molar, a second molar, and a third molar. In FIG. 1, the dental arch 51 is a lower dental arch of the patient, and the orthodontic appliance 10 is configured for the plurality of teeth 50 of the lower dental arch. Alternatively, the dental arch 51 may be an upper dental arch of the patient, and the orthodontic appliance 10 may be configured for the plurality of teeth 50 of the upper dental arch.

The orthodontic appliance 10 may be worn by the patient. The orthodontic appliance 10 may be configured to move one or more teeth 50 from the plurality of teeth 50 toward a desired tooth arrangement.

In some embodiments, as shown in FIG. 1, the orthodontic appliance 10 may include an aligner. Specifically, the orthodontic appliance 10 may include a plurality of tooth receiving cavities 12 configured to receive and reposition the one or more teeth 50 toward the desired tooth arrangement. Aligners may also be referred to as “clear tray aligners” or “CTAs.”

In some cases, the orthodontic treatment may include a plurality of orthodontic treatment stages, where each successive orthodontic treatment stage may be designed to incrementally move the one or more teeth 50 toward the desired tooth arrangement. In such cases, the orthodontic treatment may incorporate a successive application of a series, or sequence, of aligners corresponding to the plurality of orthodontic treatment stages to achieve the desired tooth arrangement of the one or more teeth 50.

The desired tooth arrangement may be based on desired functional and aesthetic attributes of the one or more teeth 50. In some cases, the desired tooth arrangement may be further based on a preference of the patient, and/or patient-specific dental anatomy of the patient. However, the desired tooth arrangement may be limited by various factors related to the one or more teeth 50 and/or the dental arch 51 of the patient. Therefore, it may be beneficial to optimize the desired tooth arrangement, and/or the plurality of orthodontic treatment stages of the orthodontic treatment based on the various factors related to the one or more teeth 50 and the dental arch 51 of the patient.

The orthodontic treatment, or more specifically, the plurality of orthodontic treatment stages and the desired tooth arrangement may be optimized using the computer-implemented method of the present disclosure. Furthermore, the orthodontic appliance 10 may be optimally designed and manufactured using the computer-implemented method of the present disclosure.

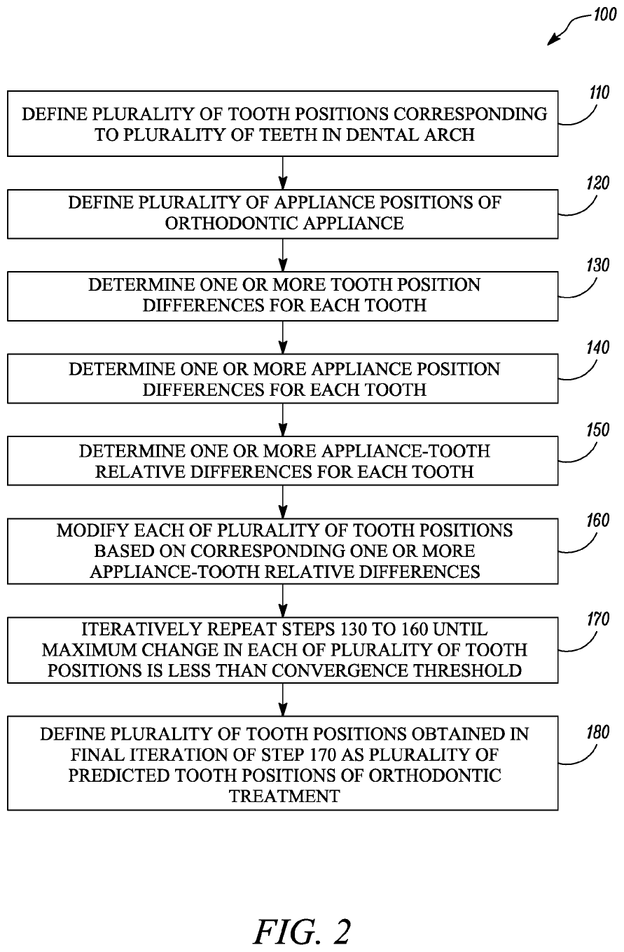

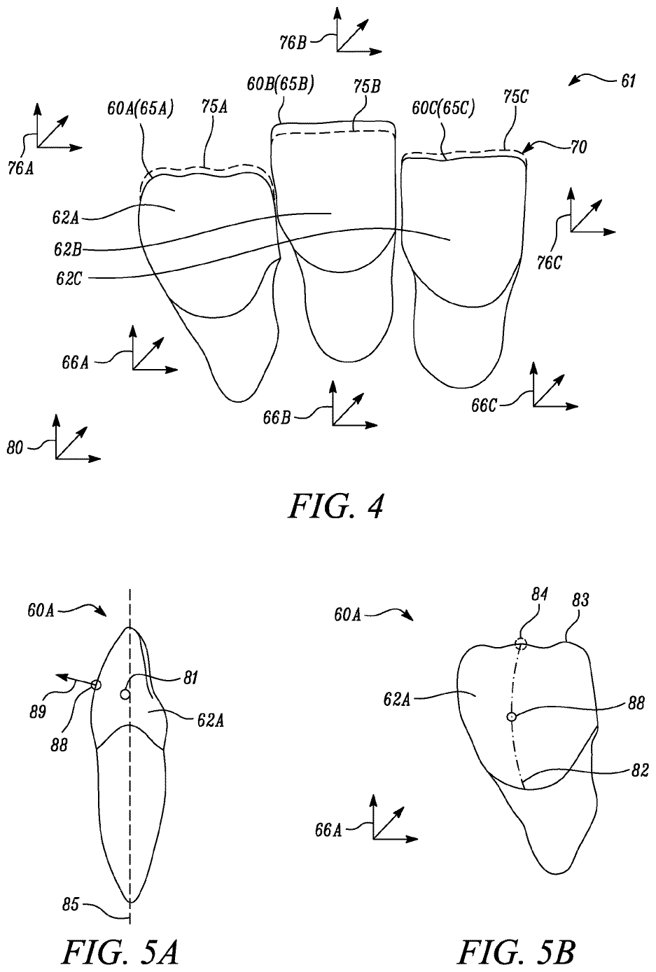

FIG. 2 illustrates a flowchart depicting various steps of a computer-implemented method 100 for predicting tooth positions in an orthodontic treatment according to an embodiment of the present disclosure. The computer-implemented method 100 may be employed to plan, optimize, and/or modify the orthodontic treatment, or more specifically, one or more orthodontic treatment stages of the orthodontic treatment. As will be discussed later, the computer-implemented method 100 may be employed to optimally design and manufacture one or more orthodontic appliances for use in the orthodontic treatment. The computer-implemented method 100 will be described with further reference to FIGS. 4-7.

At step 110, the computer-implemented method 100 includes defining a plurality of tooth positions corresponding to a plurality of teeth in a dental arch. Each tooth position from the plurality of tooth positions is defined by a tooth coordinate system that is associated with a crown of a respective tooth from the plurality of teeth.

The computer-implemented method 100 may include obtaining dental information corresponding to the plurality of teeth prior to defining the plurality of tooth positions of the plurality of teeth. The dental information may include, but is not limited to, the position, shape, size, type, and/or physiological properties of each of the plurality of teeth.

The dental information may be obtained using any suitable method. In some examples, the dental information may be obtained by scanning a mouth of the patient. Scanning techniques include, but are not limited to, manual measurement, contact scanning, and non-contact scanning. Contact scanning methods may include actual or computer-assisted measurements. Non-contact scanning methods may include, but are not limited to, laser scanning, optical scanning, CT scanning, ultrasound scanning, X-ray scanning, and so forth.

In some cases, multiple scanning steps may be combined to obtain the dental information. For example, multiple X-ray scans, multiple ultrasound scans, and/or multiple CT scans may be combined to obtain the dental information. In some examples, one or more images of the mouth of the patient may be digitized and/or analyzed to obtain the dental information.

The plurality of tooth positions may be defined based on the dental information corresponding to the plurality of teeth. The dental information may be further used to determine one or more factors for each of the plurality teeth that affect its movement, as will be discussed later.

Referring to FIG. 4, for example, the computer-implemented method 100 may include defining a plurality of tooth positions 65A, 65B. 65C corresponding to a plurality of teeth 60A. 60B, 60C in a dental arch 61. The dental arch 61 may be similar to the dental arch 51 shown in FIG. 1. A portion of the dental arch 61 is shown in FIG. 4. The tooth position 65A may correspond to the tooth 60A, the tooth position 65B may correspond to the tooth 60B, and the tooth position 65C may correspond to the tooth 60C.

The tooth position 65A may be defined by a tooth coordinate system 66A that is associated with a crown 62A of the tooth 60A. Further, the tooth position 65B may be defined by a tooth coordinate system 66B that is associated with a crown 62B of the tooth 60B. Moreover, the tooth position 65C may be defined by a tooth coordinate system 66C that is associated with a crown 62C of the tooth 60C. It may be noted that the tooth coordinate systems 66A, 66B, 66C are shown away from the crowns 62A, 62B, 62C, respectively, in FIG. 4 for illustrative purposes only. It should be readily understood that the tooth coordinate system 66A will be defined at a point associated with the crown 62A, the tooth coordinate system 66B will be defined at a point associated with the crown 62B, and the tooth coordinate system 66C will be defined at a point associated with the crown 62C.

The tooth coordinate system defining the respective tooth position may be defined at any point associated with the crown of the respective tooth. In some embodiments, the tooth coordinate system defining the respective tooth position may be defined at a three-dimensional geometric center of the crown, at a facial axis point of the crown, or at a center of an incisal edge of the crown of the respective tooth. Specifically, in some embodiments, the origin of the tooth coordinate system defining the respective tooth position may be located at the three-dimensional geometric center of the crown, a point on the facial axis of the crown, or the center of the incisal edge of the crown of the respective tooth.

Referring to FIGS. 4, 5A and 5B, for example, the tooth coordinate system 66A that defines the tooth position 65A of the tooth 60A may be defined at a three-dimensional geometric center 81 (schematically depicted by a circle in FIGS. 5A and 5B) of the crown 62A, at a facial axis point 88 on the facial axis 82 (schematically depicted by a dash-dot curve in FIG. 5B) of the crown 62A, or at a center 84 (schematically depicted by a dashed-circle in FIG. 5B) of an incisal edge 83 of the crown 62A of the tooth 60A. In some examples, the origin of the tooth coordinate system 66A may be located at the three-dimensional geometric center 81, a facial axis point 88 on the facial axis 82, or the center 84 of the incisal edge 83 of the crown 62A.

In some embodiments, the tooth coordinate system defining the respective tooth position may be defined with at least one of its axes aligned with the incisal edge 83 of the crown 62A, a long axis 85 of the respective tooth 60A, or a vector 89 normal to the crown of the respective tooth at the facial axis point 88. In other words, at least one axis of the tooth coordinate system 66A defining the respective tooth position may be aligned with the incisal edge 83 of the crown 62A, the long axis 85 of the respective tooth 60A, or a vector 89 normal to the crown 62A of the respective tooth 60A at the facial axis point 88.

Referring to FIGS. 4, 5A and 5B, for example, the tooth coordinate system 66A that defines the tooth position 65A of the tooth 60A may be defined with at least one of its axes aligned with the incisal edge 83 of the crown 62A, a long axis 85 of the tooth 60A, or a vector 89 normal to the crown of the respective tooth at the facial axis point 88 of the crown 62A of the tooth 60A.

At step 120, the computer-implemented method 100 further includes defining a plurality of appliance positions of an orthodontic appliance. Each appliance position from the plurality of appliance positions is defined by an appliance coordinate system that is associated with the orthodontic appliance and corresponds to the respective tooth. In some embodiments, the appliance coordinate system may be associated with a tooth receiving cavity of the orthodontic appliance that corresponds to the respective tooth.

Referring to FIG. 4, for example, the computer-implemented method 100 may include defining a plurality of appliance positions 75A. 75B, 75C (depicted by dashed lines in FIG. 4) of an orthodontic appliance 70. It may be noted that the orthodontic appliance 70 and the plurality of appliance positions 75A, 75B, 75C are schematically depicted in FIG. 4 for illustrative purposes only. The orthodontic appliance 70 may be similar to the orthodontic appliance 10 of FIG. 1.

The appliance position 75A may be defined by an appliance coordinate system 76A that is associated with the orthodontic appliance 70 and corresponds to the tooth 60A. Further, the appliance position 75B may be defined by an appliance coordinate system 76B that is associated with the orthodontic appliance 70 and corresponds to the tooth 60B. Moreover, the appliance position 75C may be defined by an appliance coordinate system 76C that is associated with the orthodontic appliance 70 and corresponds to the tooth 60C. It may be noted that the appliance coordinate systems 76A. 76B, 76C are shown away from the orthodontic appliance 70 in FIG. 4 for illustrative purposes only. It should be readily understood that the appliance coordinate system 76A will be defined at a point associated with the orthodontic appliance 70 which corresponds to the tooth 60A, the appliance coordinate system 76B will be defined at a point associated with the orthodontic appliance 70 which corresponds to the tooth 60B, and the appliance coordinate system will be defined at a point associated with the orthodontic appliance 70 which corresponds to the tooth 60C.

In some embodiments, the appliance coordinate system defining the respective appliance position may be defined at a point associated with the orthodontic appliance and corresponding to the three-dimensional geometric center of the crown, the facial axis point of the crown, or the center of the incisal edge of the crown of the respective tooth. Specifically, in some embodiments, the origin of the appliance coordinate system defining the respective appliance position may be located at the point associated with the orthodontic appliance and corresponding to the three-dimensional geometric center of the crown, the facial axis point of the crown, or the center of the incisal edge of the crown of the respective tooth. The origin of the appliance coordinate system may be a point within the tooth receiving cavity of the orthodontic appliance that engages with or is adjacent to a corresponding point (e.g., the geometric center of the crown) of the respective tooth.

Referring to FIGS. 4, 5A, and 5B, for example, the appliance coordinate system 76A that defines the appliance position 75A may be defined at a point associated with the orthodontic appliance 70. The point may correspond to the three-dimensional geometric center 81 of the crown 62A, the facial axis point 88 of the crown 62A, or the center 84 of the incisal edge 83 of the crown 62A of the tooth 60A. In some examples, the origin of the appliance coordinate system 76A may be located at the three-dimensional geometric center 81 of the crown 62A, the facial axis point 88 of the crown 62A, or the center 84 of the incisal edge 83 of the crown 62A of the tooth 60A.

In some embodiments, the appliance coordinate system defining the respective appliance position may be defined with at least one of its axes aligned with an aspect of the orthodontic appliance corresponding to the incisal edge 83 of the crown 62A, the long axis 85 of the respective tooth 60A, or a vector 89 normal to the crown of the respective tooth at the facial axis point 88t. In other words, at least one axis of the appliance coordinate system defining the respective appliance position may be aligned with the aspect of the orthodontic appliance which corresponds to the incisal edge 83 of the crown 62A, the long axis 85 of the respective tooth 60A, or a vector 89 normal to the crown 62A of the respective tooth 60A at the facial axis point 88. The aspect of the orthodontic appliance may be a geometric aspect thereof.

Referring to FIGS. 4.5A and 5B, for example, the appliance coordinate system 76A defining the appliance position 75A may be defined with at least one of its axes aligned with an aspect of the orthodontic appliance 70 that corresponds to the incisal edge 83 of the crown 62A, the long axis 85 of the tooth 60A, or a vector 89 normal to the face of the crown 62A of the respective tooth 60A at the facial axis point 88 of the crown 62A.

In some embodiments, the orthodontic treatment may include a plurality of orthodontic treatment stages. The plurality of appliance positions may correspond to a plurality of tooth positions that is desired to be achieved by use of the orthodontic appliance, for example, in an orthodontic treatment stage. In some examples, the plurality of appliance positions may correspond to a plurality of tooth receiving cavities of the orthodontic appliance in a relaxed state thereof. The relaxed state refers to a state of the orthodontic appliance in which it is not subjected to a stress, such as a stress subjected on the orthodontic appliance when it is placed or worn on a plurality of teeth.

In some embodiments, when the orthodontic treatment stage is a first orthodontic treatment stage, the plurality of tooth positions in step 110 may be defined as a plurality of initial tooth positions of the plurality of teeth. Furthermore, the plurality of appliance positions in step 120 may be defined as a plurality of desired tooth positions of the plurality of teeth of the first orthodontic treatment stage. In such embodiments, the plurality of tooth positions may represent an initial maloccluded tooth arrangement of the plurality of teeth, and the plurality of appliance positions may represent a desired tooth arrangement of the plurality of teeth to be achieved in the first orthodontic treatment stage.

In some embodiments, when the orthodontic treatment stage is subsequent to the first orthodontic treatment stage, the plurality of tooth positions in step 110 may be defined as a plurality of desired tooth positions of the plurality of teeth of a previous orthodontic treatment stage. Furthermore, the plurality of appliance positions in step 120 may be defined as a plurality of desired tooth positions of the plurality of teeth of a current orthodontic treatment stage. In such embodiments, the plurality of tooth positions may represent a desired tooth arrangement of the plurality of teeth to be achieved in the previous orthodontic treatment stage, and the plurality of appliance positions may represent a desired tooth arrangement of the plurality of teeth to be achieved in the current orthodontic treatment stage.

In some other embodiments, when the orthodontic treatment stage is subsequent to the first orthodontic treatment stage, the plurality of tooth positions in step 110 may be defined as the plurality of predicted tooth positions of the plurality of teeth of a previous orthodontic treatment stage. Furthermore, the plurality of appliance positions in step 120 may be defined as a plurality of desired tooth positions of the plurality of teeth of a current orthodontic treatment stage. In such embodiments, the plurality of tooth positions may represent a predicted tooth arrangement of the plurality of teeth that is predicted by the computer-implemented method 100 in the previous orthodontic treatment stage (which may be different from a desired tooth arrangement of the previous orthodontic treatment stage), and the plurality of appliance positions may represent a desired tooth arrangement of the plurality of teeth to be achieved in the current orthodontic treatment stage.

Thus, the plurality of tooth positions and the plurality of appliance positions may be defined as per planning and/or staging requirements of the orthodontic treatment.

At step 130, the computer-implemented method 100 further includes determining, for each tooth, one or more tooth position differences. Each of the one or more tooth position differences is defined as a difference between the tooth position of a respective adjacent tooth that is adjacent (i.e., directly adjacent or nearest neighboring) to the respective tooth and the tooth position of the respective tooth.

Referring to FIG. 4, for example, the computer-implemented method 100 may include determining one or more tooth position differences for each of the plurality of teeth 60A, 60B. 60C. That is, the computer-implemented method 100 may determine one or more tooth position differences for the tooth 60A, one or more tooth position differences for the tooth 60B, and one or more tooth position differences for the tooth 60C.

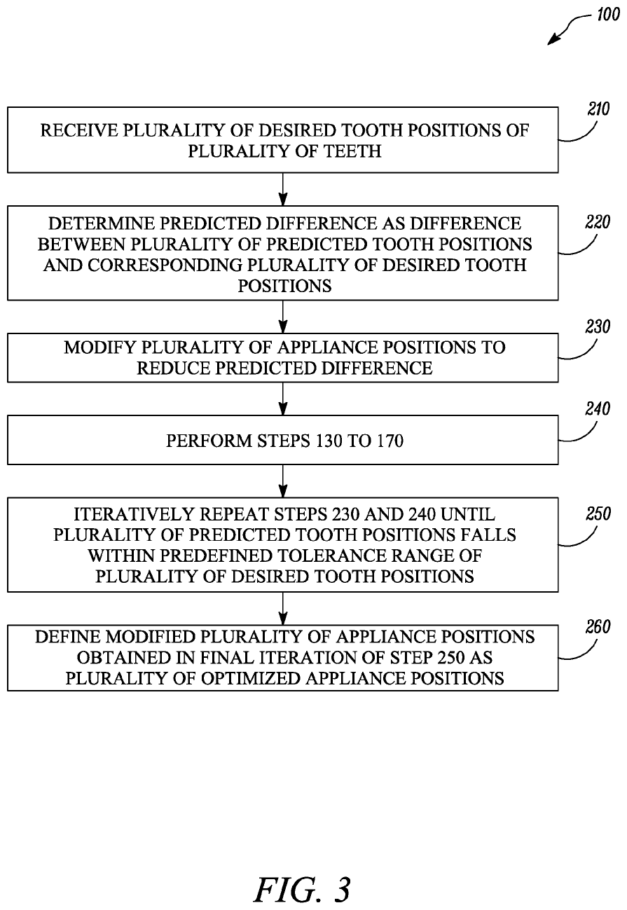

The computer-implemented method 100 may further include transforming the tooth coordinate system corresponding to the respective tooth into a global coordinate system prior to determining, for each tooth, the one or more tooth position differences. The computer-implemented method 100 may define each of the plurality of tooth positions by the global coordinate system. Thereafter, the computer-implemented method 100 may determine the one or more tooth position differences for each of the plurality of teeth. Referring to FIG. 3, for example, the computer-implemented method 100 may transform each of the tooth coordinate systems 66A, 66B, 66C into a global coordinate system 80 prior to determining the one or more tooth position differences for each of the plurality of teeth 60A, 60B, 60C.

Each of the one or more tooth position differences may be defined as the tooth position of the respective tooth subtracted from the tooth position of the respective adjacent tooth, which may be an adjacent tooth or the nearest neighboring tooth on the respective side if the patient is missing what would be the adjacent tooth. Referring to FIG. 4, for example, for the tooth 60A, the one or more tooth position differences (TPD) may include:

$$TPD ( 60 B , 60 A ) = ( 65 B ) - ( 65 A )$$

Furthermore, for the tooth 60B, the one or more tooth position differences (TPD) may include:

$$TPD ( 60 A , 60 B ) = ( 65 A ) - ( 65 B )$$

$$TPD ( 60 C , 60 B ) = ( 65 C ) - ( 65 B )$$

Moreover, for the tooth 60C, the one or more tooth position differences (TPD) may include:

$$TPD ( 60 B , 60 C ) = ( 65 B ) - ( 65 C )$$

At step 140, the computer-implemented method 100 further includes determining, for each tooth, one or more appliance position differences. Each of the one or more appliance position differences is defined as a difference between the appliance position corresponding to the respective adjacent tooth that is adjacent to the respective tooth and the appliance position corresponding to the respective tooth.

Referring to FIG. 4, for example, the computer-implemented method 100 may include determining one or more appliance position differences for each of the plurality of teeth 60A, 60B, 60C. That is, the computer-implemented method 100 may determine one or more appliance position differences for the tooth 60A, one or more appliance position differences for the tooth 60B, and one or more appliance position differences for the tooth 60C.

The computer-implemented method 100 may further include transforming the appliance coordinate system corresponding to the respective tooth into the global coordinate system prior to determining, for each tooth, the one or more appliance position differences. The computer-implemented method 100 may define each of the plurality of appliance positions by the global coordinate system. Thereafter, the computer-implemented method 100 may determine the one or more appliance position differences for each of the plurality of teeth. Referring to FIG. 4, for example, the computer-implemented method 100 may transform each of the appliance coordinate systems 76A, 76B, 76C into the global coordinate system 80 prior to determining the one or more appliance position differences for each of the plurality of teeth 60A, 60B, 60C.

Each of the one or more appliance position differences may be defined as the appliance position corresponding to the respective tooth subtracted from the appliance position corresponding to the respective adjacent tooth. Referring to FIG. 4, for example, for the tooth 60A, the one or more appliance position differences (APD) may include:

$$APD ( 60 B , 60 A ) = ( 75 B ) - ( 75 A )$$

Furthermore, for the tooth 60B, the one or more appliance position differences (APD) may include:

$$APD ( 60 A , 60 B ) = ( 75 A ) - ( 75 B )$$

$$APD ( 60 C , 60 B ) = ( 75 C ) - ( 75 B )$$

Moreover, for the tooth 60C, the one or more appliance position differences (APD) may include:

$$APD ( 60 B , 60 C ) = ( 75 B ) - ( 75 C )$$

At step 150, the computer-implemented method 100 further includes determining, for each tooth, one or more appliance-tooth relative differences. Each of the one or more appliance-tooth relative differences is based on the one or more tooth position differences and the one or more appliance position differences of the respective tooth.

The computer-implemented method 100 may further include transforming the tooth coordinate system and the appliance coordinate system corresponding to the respective tooth into the global coordinate system prior to determining, for each tooth, the one or more appliance-tooth relative differences. Referring to FIG. 4, for example, the computer-implemented method 100 may transform each of the tooth coordinate systems 66A, 66B, 66C and each of the appliance coordinate systems 76A, 76B, 76C into the global coordinate system 80 prior to determining the one or more appliance-tooth relative differences for each of the plurality of teeth 60A. 60B, 60C.

Each of the one or more appliance-tooth relative differences may be defined as a difference between a respective appliance position difference from the one or more appliance position differences and a respective tooth position difference from the one or more tooth position differences divided by an absolute value of the respective appliance position difference. Each of the one or more appliance-tooth relative differences may represent movements in translational or rotational degrees of freedom. Therefore, the computer-implemented method 100 may account for movement of each of the plurality of teeth in six degrees of freedom (e.g., three rotational and three translational degrees of freedom).

Referring to FIG. 4, for example, for the tooth 60A, the one or more appliance-tooth relative differences (ATPD) may include:

$$ATPD ( 60 B , 60 A ) = \frac{( APD ( 60 B , 60 A ) - TPD ( 60 B , 60 A ) )}{\vert APD ( 60 B , 60 A ) \vert}$$

Furthermore, for the tooth 60B, the one or more appliance-tooth relative differences (ATPD) may include:

$$ATPD ( 60 A , 60 B ) = \frac{( APD ( 60 A , 60 B ) - TPD ( 60 A , 60 B ) )}{\vert APD ( 60 A , 60 B ) \vert}$$

$$ATPD ( 60 B , 60 A ) = \frac{( APD ( 60 C , 60 B ) - TPD ( 60 C , 60 B ) )}{\vert APD ( 60 C , 60 B ) \vert}$$

Moreover, for the tooth 60C, the one or more appliance-tooth relative differences (ATPD) may include:

$$ATPD ( 60 B , 60 C ) = \frac{( APD ( 60 B , 60 C ) - TPD ( 60 B , 60 C ) )}{\vert APD ( 60 B , 60 C ) \vert}$$

At step 160, the computer-implemented method 100 further includes modifying each of the plurality of tooth positions based on the corresponding one or more appliance-tooth relative differences. A change in each of the plurality of tooth positions is less than or equal to a maximum predetermined change value.

The maximum predetermined change value may be smaller than a magnitude of expected tooth movements. Specifically, the maximum predetermined change value may be a small positive value, for example, 1 micron. The maximum predetermined change value may be constant for each of the plurality of teeth.

In some embodiments, modifying each of the plurality of tooth positions based on the one or more appliance-tooth relative difference may include determining, for each tooth, a position modification data based at least on the respective one or more appliance-tooth relative difference. In some embodiments, modifying each of the plurality of tooth positions based on the one or more appliance-tooth relative difference may further include adding, to each tooth position, the position modification data of the respective tooth. In other words, modifying a tooth position of a tooth may include adding the position modification data of the tooth to the tooth position of the tooth.

Referring to FIG. 4, for example, modifying the tooth position 65A of the tooth 60A may include determining a position modification data (PMD (60A)) based on the one or more appliance-tooth relative differences for the tooth 60A (i.e., ATPD (60B, 60A)), and adding the position modification data (PMD (60A)) to the tooth position 65A (i.e., 65A+(PMD (60A)).

In some embodiments, determining the position modification data for each tooth may further include determining a combined relative difference as a sum of the one or more appliance-tooth relative differences of the respective tooth.

Referring to FIG. 3, for example, for the tooth 60B, determining the position modification data (PMD (60B) may include determining a combined relative difference (CRD (60B)) as a sum of the one or more appliance-tooth relative differences of the tooth 60B. That is,

$$CRD ( 60 B ) = ATPD ( 60 A , 60 B ) + ATPD ( 60 C , 60 B ) .$$

In case of the tooth 60A, its combined relative difference (CRD (60A)) may be equal to ATPD (60B, 60A), as there is only one adjacent tooth (i.e., 60B) for the tooth 60A. Similarly, in the case of the tooth 60C, its combined relative difference (CRD (60C)) may be equal to ATPD (60B, 60C), as there is only one adjacent tooth (i.e., 60B) for the tooth 60C.

In other words, CRD (60A)=ATPD (60B, 60A) and CRD (60C)=ATPD (60B, 60C).

In some embodiments, determining the position modification data for each tooth may further include determining a combined maximum difference value as a maximum absolute value of the one or more appliance-tooth relative differences among the plurality of teeth.

Referring to FIG. 4, for example, for the tooth 60B, determining the position modification data (PMD (60B)) may include determining a combined maximum difference value (CMDV) as a maximum absolute value of the one or more appliance-tooth relative differences among the plurality of teeth 60A, 60B, 60C. That is, the combined maximum difference value (CMDV) may be the maximum absolute value among ATPD (60B, 60A). ATPD (60A, 60B), ATPD (60C, 60B), and ATPD (60, 60C).

In other words, CMDV=MAXIMUM (ATPD (60B, 60A), ATPD (60A, 60B), ATPD (60C, 60B), ATPD (60B, 60C)).

In some embodiments, determining the position modification data for each tooth may further include determining the position modification data as a product of the maximum predetermined change value (MPCV) and a negative of a ratio of the combined relative difference of the respective tooth to the combined maximum difference value of the plurality of teeth.

Referring to FIG. 4, for example, for the tooth 60B, the position modification data (PMD (60)) may be determined as:

$$PMD ( 60 B ) = MPCV \times ( - \frac{CRD ( 60 B )}{CMDV} )$$

In some embodiments, the computer-implemented method 100 may further include determining a tooth movement factor for each tooth. The tooth movement factor may have a minimum value for an absolute magnitude of the combined relative difference (i.e., |CRDI) of the respective tooth that is less than a first threshold magnitude. Further, the tooth movement factor may have a maximum value for the absolute magnitude of the combined relative difference of the respective tooth that is greater than a second threshold magnitude. The tooth movement factor may be used to model advanced relationships between tooth movement and the combined relative difference.

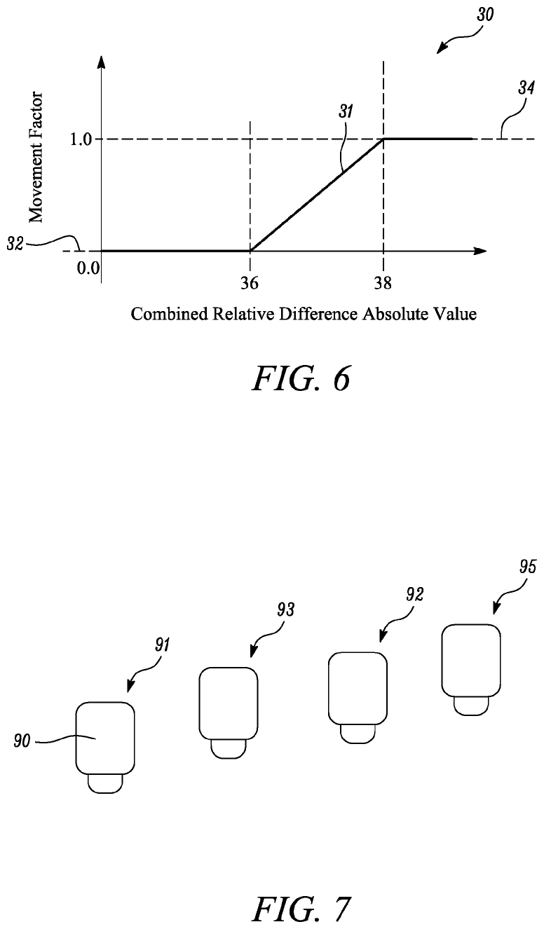

FIG. 6 illustrates a graph 30 depicting a variation of the tooth movement factor with respect to the absolute value of the combined relative difference of a tooth according to an embodiment of the present disclosure. The absolute value of the combined relative difference is represented in the abscissa (X-axis). The tooth movement factor is represented in the ordinate (Y-axis).

The graph 30 includes a curve 31 representing a value of the tooth movement factor with respect to the absolute value of the combined relative difference. As depicted by the curve 31, the tooth movement factor may have a minimum value 32 for the absolute magnitude of the combined relative difference of the tooth that is less than a first threshold magnitude 36. Furthermore, the tooth movement factor may have a maximum value 34 for the absolute magnitude of the combined relative difference of the tooth that is greater than a second threshold magnitude 38.

Referring to FIGS. 4 and 6, for example, for the tooth 60A, if the absolute magnitude of combined relative difference (i.e., |CRD (60A)|) is less than the first threshold magnitude 36, the tooth movement factor of the tooth 60A may be equal to the minimum value 32. Alternatively, for the tooth 60A, if the absolute magnitude of combined relative difference (i.e., |CRD (60A)|) is greater than the second threshold magnitude 38, the tooth movement factor of the tooth 60A may be equal to the maximum value 34. That is, if |CRD (60A)|<first threshold magnitude 36, then tooth movement factor=the minimum value 32, and if |CRD (60A)|>second threshold magnitude 38, then tooth movement factor=maximum value 34.

In some embodiments, the minimum value of the tooth movement factor may be 0 and the maximum value of the tooth movement factor may be 1. For example, the minimum value 32 of the tooth movement factor may be 0 and the maximum value 34 of the tooth movement factor may be 1.

In some embodiments, for the absolute magnitude of the combined relative difference of the respective tooth that is greater than the first threshold magnitude and less than the second threshold magnitude, the tooth movement factor may increase linearly from the minimum value to the maximum value with respect to the magnitude of the combined relative difference.

For example, as depicted by the curve 31, for the absolute magnitude of the combined relative difference of the tooth that is greater than the first threshold magnitude 36 and less than the second threshold magnitude 38, the tooth movement factor may increase linearly from the minimum value 32 to the maximum value 34 with respect to the magnitude of the combined relative difference.

Referring to FIGS. 4 and 6, for example, for the tooth 60A, if the absolute magnitude of combined relative difference (i.e., |CRD (60A)|) is greater than the first threshold magnitude 36 and less than the second threshold magnitude 38, the tooth movement factor of the tooth 60A may be proportional to the absolute magnitude of combined relative difference for the tooth 60A.

That is, if first threshold magnitude 36<(|CRD (60A)|<second threshold magnitude 38, then

$$tooth movement factor = \frac{\vert CRD ( 60 A ) \vert - first threshold magnitude 36}{second threshold magnitude 38 - first threshold magnitude 36}$$

In some examples, the first threshold magnitude may be equal to zero, such that the movement factor may be non-zero when the absolute magnitude of combined relative difference is non-zero. In some examples, the first threshold magnitude and the second threshold magnitude may be equal to each other, such that that the movement factor may have the form of a step-function. Alternate functions, including non-linear functions, may be selected for defining the movement factor for the absolute magnitude of combined relative difference between the first threshold magnitude and second threshold magnitude.

In some embodiments, the position modification data may be further determined as a product of the tooth movement factor (TMF), the maximum predetermined change value (MPCV), and the negative of the ratio of the combined relative difference (CRD) of the respective tooth to the combined maximum difference value (CMDV) of the plurality of teeth.

Referring to FIG. 4, for example, in some embodiments, the position modification data (PMD (60B)) for the tooth 60B may be determined as:

$$PMD ( 60 B ) = TMF \times MPCV \times ( - \frac{C R D ( 60 B )}{CMDV} )$$

It may be beneficial to account for relative tooth movement of the plurality of teeth. In some embodiments, the computer-implemented 100 may further include determining one or more tooth resistance parameters of each of the plurality of teeth based on a geometry of the respective tooth. In some embodiments, the computer-implemented 100 may further include assigning a tooth resistance factor to each of the plurality of teeth based on the one or more tooth resistance parameters. In some embodiments, the position modification data may be further determined as a product of the tooth resistance factor (TRF), the tooth movement factor (TMF), the maximum predetermined change value (MPCV), and the negative of the ratio of the combined relative difference (CRD) of the respective tooth to the combined maximum difference value (CMDV) of the plurality of teeth.

Referring to FIG. 4, for example, in some embodiments, the position modification data (PMD (60B)) for the tooth 60B may be determined as:

$$PMD ( 60 B ) = T RF \times TMF \times MPCV \times ( - \frac{CRD ( 60 B )}{CMDV} )$$

The one or more tooth resistance parameters of each of the plurality of teeth may be based on at least one of a size of the respective tooth and a number of roots of the respective tooth. The tooth resistance factor of a larger tooth may be less than the tooth resistance factor of a smaller tooth. Moreover, the tooth resistance factor of a tooth having more roots may be less than the tooth resistance factor of a tooth having fewer roots. For example, molars having three roots may move slower than incisors having one root. As an example, if it is considered that the molars having three roots move three times slower than the incisors having one root, the tooth resistance factor for each of the incisors having one root may be 1 and the tooth resistance factors for each of the molars having three roots may be ⅓. As a result, the modification of tooth positions of the molars having three roots may be reduced by about 67% relative to the modification of tooth positions of the incisors having one root.

Furthermore, the tooth resistance factor may be correlated to clinical data or based on other expectations of relative tooth movement propensities. For example, an artificial tooth (i.e., an implant) screwed into a jaw-bone of the patient may be expected to not move at all. In this case, a very small value, for example, 1/1000, may be assigned to the artificial tooth.

At step 170, the computer-implemented method 100 further includes iteratively repeating steps 130 to 160 until a maximum change in each of the plurality of tooth positions is less than a convergence threshold. The convergence threshold may have a small value, for example, 0.001 microns.

In some embodiments, step 170 may be limited to a predefined iteration limit. Specifically, in some embodiments, if iteratively repeating steps 130 to 160 takes a greater number of iterations than the predefined iteration limit, the computer-implemented method 100 may further include ending iteratively repeating steps 130 to 160. The computer-implemented method 100 may further include undoing the modifications to the plurality of tooth positions. The computer-implemented method 100 may further include reducing the maximum predetermined change value (e.g., from 1 micron to 0.1 microns). The computer-implemented method 100 may further include performing steps 130 to 160 with the reduced maximum predetermined change value.

At step 180, the computer-implemented method 100 further includes defining the plurality of tooth positions obtained in the final iteration of step 170 as a plurality of predicted tooth positions of the orthodontic treatment.

In some embodiments, the computer-implemented method 100 may include defining the plurality of tooth positions obtained in the final iteration of step 170 as a plurality of predicted tooth positions of an orthodontic treatment stage of the orthodontic treatment.

The computer-implemented method 100, and more specifically, the plurality of predicted tooth positions may be used to pursue improved orthodontic appliance designs with increased probability of achieving planned or desired tooth movements. In particular, by practicing techniques disclosed herein computing systems specifically adapted to generate oral care appliance constructions are improved. Furthermore, with the improvements in design and accuracy, both the time necessary to generate one or more appliances and the time necessary to devote to treatment may be reduced.

FIG. 3 illustrates a flowchart depicting various steps of the computer-implemented method 100 according to an embodiment of the present disclosure. The computer-implemented method 100 may further include the following steps. Reference will also be made to FIG. 2.

At step 210, the computer-implemented method 100 may further include receiving a plurality of desired tooth positions of the plurality of teeth. Each desired tooth position from the plurality of desired tooth positions may be defined by the appliance coordinate system associated with the crown of the respective tooth.

Referring to FIG. 7, for example, the computer-implemented method 100 may include receiving a desired tooth position 92 of a tooth 90. The computer-implemented method 100 may further include receiving an initial tooth position 91 of the tooth 90.

At step 220, the computer-implemented method 100 may further include determining a predicted difference as a difference between the plurality of predicted tooth positions and the corresponding plurality of desired tooth positions. The plurality of predicted tooth positions is defined at step 180 that is described above with reference to FIG. 2.

Referring to FIG. 7, for example, the computer-implemented method 100 may further include determining a predicted difference as a difference between the desired tooth position 92 of the tooth 90 and a predicted position 93 of the tooth 90. The computer-implemented method 100 may determine the predicted position 93 based on the initial tooth position 91 and the desired tooth position 92. Specifically, to determine the predicted position 93 of the tooth 90 by the computer-implemented method 100, the initial tooth position 91 may be defined as the tooth position of the tooth 90 in step 110 (shown in FIG. 2) of the computer-implemented method 100, and the desired tooth position 92 may be defined as the appliance position corresponding to the tooth 90 in step 120 (shown in FIG. 2) of the computer-implemented method 100.

At step 230, the computer-implemented method 100 may further include modifying the plurality of appliance positions to reduce the predicted difference.

At step 240, the computer-implemented method 100 may further include performing steps 130 to 170 that are described above with reference to FIG. 2. The computer-implemented method 100 may thus predict tooth movements based on the modified plurality of appliance positions obtained in step 230.

At step 250, the computer-implemented method 100 may further include iteratively repeating steps 230 and 240 until the plurality of predicted tooth positions falls within a predefined tolerance range of the plurality of desired tooth positions.

At step 260, the computer-implemented method 100 may further include defining the modified plurality of appliance positions obtained in the final iteration of step 250 as a plurality of optimized appliance positions.

Referring to FIG. 7, for example, the computer-implemented method 100 may determine an optimized aligner position 95 for moving the tooth 90 from the initial tooth position 91 to the desired tooth position 92, for example, in an orthodontic treatment stage of the orthodontic treatment.

In some embodiments, the computer-implemented method 100 may further include manufacturing the orthodontic appliance based on the plurality of optimized appliance positions. In some embodiments, the plurality of optimized appliance positions may correspond to a respective plurality of tooth receiving cavities of an aligner. The computer-implemented method 100 may further include manufacturing the aligner based on the plurality of optimized appliance positions.

Referring to FIG. 1, for example, the plurality of optimized appliance positions may correspond to the plurality of tooth receiving cavities 12 of the aligner 10, and the aligner 10 may be manufactured based on the plurality of optimized appliance positions.

The orthodontic appliance, and/or the aligner (or portions thereof) may be manufactured using any suitable manufacturing techniques, such as direct fabrication including additive manufacturing techniques (also referred to as “3D printing”) or subtractive manufacturing techniques (e.g., milling). In some embodiments, the orthodontic appliance, and/or the aligner may include one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and a polytrimethylene terephthalate.

In some embodiments, the orthodontic treatment may include a plurality of orthodontic treatment stages and a plurality of orthodontic appliances corresponding to the plurality of orthodontic treatment stages. The plurality of orthodontic treatment stages may include a first orthodontic treatment stage and a final orthodontic treatment stage.

The computer-implemented method 100 may further include, for each orthodontic treatment stage subsequent to the first orthodontic treatment stage, defining the plurality of tooth positions of the respective orthodontic treatment stage in step 110 as the plurality of predicted tooth positions of a previous orthodontic treatment stage. In other words, for each subsequent orthodontic treatment stage, the plurality of tooth positions may be defined as the plurality of predicted tooth positions of a current orthodontic treatment stage determined by the computer-implemented method 100 at step 180.

The computer-implemented method 100 may further include, for each orthodontic treatment stage subsequent to the first orthodontic treatment stage, defining the plurality of appliance positions in step 120 based on the orthodontic appliance that corresponds to the respective orthodontic treatment stage. In other words, for each orthodontic treatment stage, the plurality of appliance positions may be defined based on the orthodontic appliance corresponding to the orthodontic treatment stage.

The plurality of predicted tooth positions of the final orthodontic treatment stage may correspond to a plurality of final tooth positions of the plurality of teeth. The computer-implemented method 100 may be used to predict the tooth movement in each of the plurality of orthodontic treatment stages as well as the plurality of final tooth positions of the final orthodontic treatment stage. Thus, the computer-implemented method 100 may be used to predict tooth movement of a pre-planned orthodontic treatment incorporating pre-manufactured orthodontic appliances.

The computer-implemented method 100 may be used to modify the orthodontic treatment. For example, if the plurality of predicted final tooth positions does not match a plurality of desired final tooth positions within acceptable tolerance, an alternate final arrangement of the plurality of teeth may be defined based on secondary treatment goals while ensuring primary treatment goals are met. For example, if the computer-implemented method 100 determines that a tooth is too difficult to move, moving neighboring teeth may be considered instead of moving the difficult tooth for better relative alignment. As another example, arrangement/alignment of premolars and molars may be sacrificed for aesthetic alignment of anterior teeth which are more visible.

In some examples, the computer-implemented method 100 may be used to modify the staging of the orthodontic treatment. For example, if the computer-implemented method 100 is unable to sufficiently optimize a design of the orthodontic appliance, one or more additional orthodontic treatment stages may be added to the orthodontic treatment. Alternatively, if desired tooth movements are predictable and easy to achieve, the orthodontic plan may be modified to include fewer orthodontic treatment stages to reduce a number of aligners needed to be produced.

The computer-implemented method 100 may be computationally efficient and fast in predicting tooth movement, especially when compared to solid model analysis (such as finite-element methods). In some cases, the computer-implemented method 100 may reduce a time taken to predict tooth movement by over 99% compared to solid model analysis. For example, the computer-implemented method 100 may predict tooth movement in the order of minutes, as compared to days or even weeks taken by solid model analysis. As a result, the computer-implemented method 100 may be suitable for use in real-time during orthodontic treatment planning processes.

The computer-implemented method 100 may determine an effectiveness of the orthodontic appliance without calculating forces (e.g., minimum or optimal forces) that will be applied by the orthodontic appliance on the plurality of teeth, which are somewhat arbitrary and unknowable. Moreover, the computer-implemented method 100 may not require detailed root or periodontal ligament (PDL) geometry of the plurality of teeth to determine tooth movement.

The computer-implemented method 100 may account for fundamental aspects of appliance mechanics, capture reactions between neighboring teeth, and facilitate production of appliance designs that come closer to achieving intended tooth movements without using finite-element methods. The computer-implemented method 100 may further account for movement of each of the plurality of teeth in six degrees of freedom (e.g., three rotational and three translational degrees of freedom).

The computer-implemented 100 may be performed by a processor of a computing device. The processor may include any suitable type of processing circuitry, such as one or more of a general-purpose processor (e.g., ARM-based processor), a digital signal processor (DSP), a programmable logic device (PLD), an application-specific integrated circuit (ASIC), a field-programmable gate array (FPGA), etc.

Advantageously, the computer-implemented method 100 may be coded into computer-executable instructions that cause the processor of the computing device to perform various steps of the computer-implemented method 100. The computer-executable instructions may be written in any programming language, such as java, C++, python, etc. Moreover, the computer-implemented method 100 may be integrated directly into an orthodontic treatment planning software and/or orthodontic appliance design software.

### Example

An example illustrating some steps of the computer-implemented method 100 (shown in FIG. 2) will be discussed hereinafter with reference to FIG. 4. For ease of understanding, movement of each of the plurality of teeth 65A, 65B. 65C is considered only in a vertical axis. An upward movement in the vertical axis is considered to be positive, and a downward movement in the vertical axis is considered to be negative. The assumed values of the tooth positions and the appliance positions for explanation purposes are listed in Table 1 below.

TABLE 1
Assumed values of tooth positions and the appliance positions

| Tooth | Assumed Tooth | Appliance | Assumed Appliacne |
|---|---|---|---|
| Position | Position Value (mm) | Position | Position Value (mm) |
| 65A | 5.0 | 75A | 5.3 |
| 65B | 5.9 | 75B | 5.6 |
| 65C | 5.2 | 75C | 5.4 |

Calculations: The calculations below are for determining the movement of the tooth 60B in one iteration of the computer-implemented method 100 (shown in FIG. 2) of the present disclosure.

For tooth 65B, the one or more tooth position differences may be determined by the following equations:

$$TPD ( 60 B , 60 A ) = ( 65 B ) - ( 65 A )$$

$$TPD ( 60 C , 60 B ) = ( 65 C ) - ( 65 B )$$

Substituting values of the tooth positions 65A, 65B, 65C from Table 1.

$$TPD ( 60 B , 60 A ) = 5. mm - 5.9 mm = - 0.9 mm$$

$$TPD ( 60 C , 60 B ) = 5.2 mm - 5.9 mm = - 0.7 mm$$

For tooth 65B, the one or more appliance position differences may be determined by the following equations:

$$APD ( 60 A , 60 B ) = ( 75 A ) - ( 75 B )$$

$$APD ( 60 C , 60 B ) = ( 75 C ) - ( 75 B )$$

Substituting values of the appliance positions 75A, 75B, 75C from Table 1,

$$APD ( 60 A , 60 B ) = 5.3 mm - 5.6 mm = - 0.3 mm$$

$$APD ( 60 C , 60 B ) = 5.4 mm - 5.6 mm = - 0.2 mm$$

For tooth 65B, the one or more appliance-tooth relative differences may be determined by the following equations:

$$ATPD ( 60 A , 60 B ) = \frac{APD ( 60 A , 60 B ) - TPD ( 60 A , 60 B )}{\vert APD ( 60 A , 60 B ) \vert}$$

$$ATPD ( 60 C , 60 B ) = \frac{APD ( 60 C , 60 B ) - TPD ( 60 C , 60 B )}{\vert APD ( 60 A , 60 B ) \vert}$$

Substituting the values of APD (60A,60B), TPD (60A,60B), APD (60C,60B), and TPD (60C,60B) obtained above,

$$ATPD ( 60 A , 60 B ) = ( \frac{( - 0.3 mm - ( - 0.9 mm ) )}{\vert - 0.3 mm \vert} ) = 2$$

$$ATPD ( 60 C , 60 B ) = ( \frac{( - 0.2 mm - ( - 0.7 mm ) )}{\vert - 0.2 mm \vert} ) = 2.5$$

Modified tooth position may be determined by the following equation:

$$Modified tooth position = Tooth position ( i . e . , 65 B ) + Position modification data ( i . e . , PMD ( 60 B ) ) ,$$

$$where$$

$$PMD ( 60 B ) = Tooth Resistance Factor ( TRF ( 60 B ) ) \times Tooth Movement Factor ( TMF ( 60 B ) ) \times Maximum Predetermined Change Value ( MPCV ) \times - ( Combined Relative Difference ( CRD ( 60 B ) ) / Combined Maximum Difference Value ( CMDV ) ) .$$

$$PMD ( 60 B ) = TRF ( 60 B ) \times TMF ( 60 B ) \times MPCV \times - \frac{CRD ( 60 B )}{CMDV}$$

Determining the values of CRD (60B) and CMDV,

$$CRD ( 60 B ) ) = ATPD ( 60 A , 60 B ) + ATPD ( 60 C , 60 B ) = 2 + 2.5 = 4.5$$

CMDV for the plurality of teeth 60A, 60B, 60C=4.5

Assuming TRF (60B)=TMF (60B)=1 (for simplicity) and MPCV=0.001 mm, and substituting the determined values of CRD (60B) and CMDV,

$$PMD ( 60 B ) = 1 \times 1 \times 0.001 mm \times - ( \frac{4.5}{4.5} ) = - 0.001 mm$$

As discussed above, modified tooth position=Tooth position (i.e., 65B)+Position modification data (i.e., PMD (60B)), therefore,

$$Modified tooth position = 5.9 mm + ( - 0.001 mm ) = 5.899 mm$$

Therefore, a downward movement of the tooth 60B in the vertical axis by 0.001 mm (or 1 micron) may be predicted by the computer-implemented method 100 in one iteration. The modified position of the tooth 60B may be 5.899 mm (from the initial position of 5.9 mm provided in Table 1 above).

It will be appreciated that the arrangements presented herein may be varied in any number of aspects while still remaining within the scope of the disclosures herein.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A system for orthodontic treatment, the system comprising:
a computing device;
a processor;
a memory storing instructions that, when executed by the processor, configure the computing device to:
a) define a plurality of tooth positions corresponding to a plurality of teeth in a dental arch, wherein each tooth position from the plurality of tooth positions is defined by a tooth coordinate system that is associated with a crown of a respective tooth from the plurality of teeth;
b) define a plurality of appliance positions of an orthodontic appliance, wherein each appliance position from the plurality of appliance positions is defined by an appliance coordinate system that is associated with the orthodontic appliance and corresponds to the respective tooth;
c) determine, for each tooth, one or more tooth position differences, wherein each of the one or more tooth position differences is defined as a difference between the tooth position of a respective adjacent tooth that is adjacent to the respective tooth and the tooth position of the respective tooth;
d) determine, for each tooth, one or more appliance position differences, wherein each of the one or more appliance position differences is defined as a difference between the appliance position corresponding to the respective adjacent tooth that is adjacent to the respective tooth and the appliance position corresponding to the respective tooth;
e) determine, for each tooth, one or more appliance-tooth relative differences, wherein each of the one or more appliance-tooth relative differences is based on the one or more tooth position differences and the one or more appliance position differences of the respective tooth;
f) modify each of the plurality of tooth positions based on the corresponding one or more appliance-tooth relative differences, wherein a change in each of the plurality of tooth positions is less than or equal to a maximum predetermined change value;
g) iteratively repeat steps c) to f) until a maximum change in each of the plurality of tooth positions is less than a convergence threshold; and
h) define the plurality of tooth positions obtained in the final iteration of step g) as a plurality of predicted tooth positions of the orthodontic treatment.

2. The system of claim 1, wherein, if iteratively repeating steps c) to f) takes a greater number of iterations than a predefined iteration limit, the computer-implemented method further comprises:
ending iteratively repeating steps c) to f);
undoing the modifications to the plurality of tooth positions;
reducing the maximum predetermined change value; and
performing steps c) to g) with the reduced maximum predetermined change value.

3. The system of claim 1, wherein determining the position modification data for each tooth further comprises:
determining a combined relative difference as a sum of the one or more appliance-tooth relative differences of the respective tooth;
determining a combined maximum difference value as a maximum absolute value of the one or more appliance-tooth relative differences among the plurality of teeth; and
determining the position modification data as a product of the maximum predetermined change value and a negative of a ratio of the combined relative difference of the respective tooth to the combined maximum difference value of the plurality of teeth.

4. The system of claim 3, wherein the instruction further configure the computing device to:
determine a tooth movement factor for each tooth, the tooth movement factor having a minimum value for an absolute magnitude of the combined relative difference of the respective tooth that is less than a first threshold magnitude, the tooth movement factor having a maximum value for the absolute magnitude of the combined relative difference of the respective tooth that is greater than a second threshold magnitude;
wherein the position modification data is further determined as a product of the tooth movement factor, the maximum predetermined change value, and the negative of the ratio of the combined relative difference of the respective tooth to the combined maximum difference value of the plurality of teeth.

5. The system of claim 4, wherein the instruction further configure the computing device to:
determine one or more tooth resistance parameters of each of the plurality of teeth based on a geometry of the respective tooth; and
assign a tooth resistance factor to each of the plurality of teeth based on the one or more tooth resistance parameters;
wherein the position modification data is further determined as a product of the tooth resistance factor, the tooth movement factor, the maximum predetermined change value, and the negative of the ratio of the combined relative difference of the respective tooth to the combined maximum difference value of the plurality of teeth.

6. The system of claim 5, wherein the instruction further configure the computing device to:
1) receive a plurality of desired tooth positions of the plurality of teeth, wherein each desired tooth position from the plurality of desired tooth positions is defined by the appliance coordinate system associated with the crown of the respective tooth;
2) determine a predicted difference as a difference between the plurality of predicted tooth positions and the corresponding plurality of desired tooth positions;
3) modify the plurality of appliance positions to reduce the predicted difference;
4) perform steps c) to g);
5) iteratively repeat steps 3) and 4) until the plurality of predicted tooth positions falls within a predefined tolerance range of the plurality of desired tooth positions; and
6) define the modified plurality of appliance positions obtained in the final iteration of step 5) as a plurality of optimized appliance positions.

7. The system of claim 6, wherein the instruction further configure the computing device to: deliver instructions to a fabrication machine configured for manufacturing the orthodontic appliance based on the plurality of optimized appliance positions.

8. The system of claim 7, wherein the plurality of optimized appliance positions corresponds to a respective plurality of tooth receiving cavities of an aligner.

9. The system of claim 8, wherein the orthodontic treatment comprises a plurality of orthodontic treatment stages and a plurality of orthodontic appliances corresponding to the plurality of orthodontic treatment stages, the plurality of orthodontic treatment stages comprising a first orthodontic treatment stage and a final orthodontic treatment stage, and wherein the instruction further configure the computing device to:
for each orthodontic treatment stage subsequent to the first orthodontic treatment stage:
define the plurality of tooth positions of the respective orthodontic treatment stage in step a) as the plurality of predicted tooth positions of a previous orthodontic treatment stage; and
define the plurality of appliance positions in step b) based on the orthodontic appliance that corresponds to the respective orthodontic treatment stage;
wherein the plurality of predicted tooth positions of the final orthodontic treatment stage corresponds to a plurality of final tooth positions of the plurality of teeth.

10. The system of claim 6, and further comprising the fabrication machine configured for manufacturing the orthodontic appliance based on the plurality of optimized appliance positions.

11. The system of claim 10, wherein the fabrication machine comprises an additive manufacturing machine.

12. A computer-implemented method for predicting tooth movement in an orthodontic treatment, the computer-implemented method comprising:
a) defining a plurality of tooth positions corresponding to a plurality of teeth in a dental arch, wherein each tooth position from the plurality of tooth positions is defined by a tooth coordinate system that is associated with a crown of a respective tooth from the plurality of teeth;
b) defining a plurality of appliance positions of an orthodontic appliance, wherein each appliance position from the plurality of appliance positions is defined by an appliance coordinate system that is associated with the orthodontic appliance and corresponds to the respective tooth;
c) determining, for each tooth, one or more tooth position differences, wherein each of the one or more tooth position differences is defined as a difference between the tooth position of a respective adjacent tooth that is adjacent to the respective tooth and the tooth position of the respective tooth;
d) determining, for each tooth, one or more appliance position differences, wherein each of the one or more appliance position differences is defined as a difference between the appliance position corresponding to the respective adjacent tooth that is adjacent to the respective tooth and the appliance position corresponding to the respective tooth;
e) determining, for each tooth, one or more appliance-tooth relative differences, wherein each of the one or more appliance-tooth relative differences is based on the one or more tooth position differences and the one or more appliance position differences of the respective tooth;
f) modifying each of the plurality of tooth positions based on the corresponding one or more appliance-tooth relative differences, wherein a change in each of the plurality of tooth positions is less than or equal to a maximum predetermined change value;
g) iteratively repeating steps c) to f) until a maximum change in each of the plurality of tooth positions is less than a convergence threshold; and
h) defining the plurality of tooth positions obtained in the final iteration of step g) as a plurality of predicted tooth positions of the orthodontic treatment.

13. The computer-implemented method of claim 12, wherein each of the one or more tooth position differences is defined as the tooth position of the respective tooth subtracted from the tooth position of the respective adjacent tooth.

14. The computer-implemented method of claim 13, wherein each of the one or more appliance position differences is defined as the appliance position corresponding to the respective tooth subtracted from the appliance position corresponding to the respective adjacent tooth.

15. The computer-implemented method of claim 14, wherein each of the one or more appliance-tooth relative differences is defined as a difference between a respective appliance position difference from the one or more appliance position differences and a respective tooth position difference from the one or more tooth position differences divided by an absolute value of the respective appliance position difference.

16. The computer-implemented method of claim 15, wherein modifying each of the plurality of tooth positions based on the one or more appliance-tooth relative difference comprises:
determining, for each tooth, a position modification data based at least on the respective one or more appliance-tooth relative difference; and
adding, to each tooth position, the position modification data of the respective tooth.

17. The computer-implemented method of claim 16, wherein determining the position modification data for each tooth further comprises:
determining a combined relative difference as a sum of the one or more appliance-tooth relative differences of the respective tooth;
determining a combined maximum difference value as a maximum absolute value of the one or more appliance-tooth relative differences among the plurality of teeth; and
determining the position modification data as a product of the maximum predetermined change value and a negative of a ratio of the combined relative difference of the respective tooth to the combined maximum difference value of the plurality of teeth.

18. The computer-implemented method of claim 16, further comprising determining a tooth movement factor for each tooth, the tooth movement factor having a minimum value for an absolute magnitude of the combined relative difference of the respective tooth that is less than a first threshold magnitude, the tooth movement factor having a maximum value for the absolute magnitude of the combined relative difference of the respective tooth that is greater than a second threshold magnitude;
wherein the position modification data is further determined as a product of the tooth movement factor, the maximum predetermined change value, and the negative of the ratio of the combined relative difference of the respective tooth to the combined maximum difference value of the plurality of teeth.

19. (canceled)

20. The computer-implemented method of claim 18, further comprising:
1) receiving a plurality of desired tooth positions of the plurality of teeth, wherein each desired tooth position from the plurality of desired tooth positions is defined by the appliance coordinate system associated with the crown of the respective tooth;
2) determining a predicted difference as a difference between the plurality of predicted tooth positions and the corresponding plurality of desired tooth positions;
3) modifying the plurality of appliance positions to reduce the predicted difference;
4) performing steps c) to g);
5) iteratively repeating steps 3) and 4) until the plurality of predicted tooth positions falls within a predefined tolerance range of the plurality of desired tooth positions; and
6) defining the modified plurality of appliance positions obtained in the final iteration of step 5) as a plurality of optimized appliance positions,
7) manufacturing the orthodontic appliance based on the plurality of optimized appliance positions.

21. A system for selecting and fabricating an orthodontic appliance, the system comprising:
a computing device;
a processor;
a memory storing instructions that, when executed by the processor, configure the computing device to:
1) receive a plurality of desired tooth positions of the plurality of teeth, wherein each desired tooth position from the plurality of desired tooth positions is defined by an appliance coordinate system associated with the crown of the respective tooth;
2) receive a plurality of appliance positions of an orthodontic appliance, wherein each appliance position from the plurality of appliance positions is defined by an appliance coordinate system that is associated with the orthodontic appliance and corresponds to the respective tooth;
3) perform steps c) to g) of the method of claim 12;
4) determine a predicted difference as a difference between the plurality of predicted tooth positions and the corresponding plurality of desired tooth positions;
5) modify the plurality of appliance positions to reduce the predicted difference;
6) iteratively repeat steps 4) and 5) until the plurality of predicted tooth positions falls within a predefined tolerance range of the plurality of desired tooth positions;
7) define the modified plurality of appliance positions obtained in the final iteration of step 5) as a plurality of optimized appliance positions; and
8) manufacture one or more orthodontic appliances based on the plurality of optimized appliance positions.
